(19) United States
(12) Patent Application Publication
(10) Pub. No.: US 2023/0208087 A1
(43) Pub. Date: Jun. 29, 2023

(54) FAKRA Connector

(71) Applicant: SUZHOU KONIG ELECTRONIC TECHNOLOGY CO., LTD., Suzhou City (CN)

(72) Inventor: Jason Zhu, Suzhou City (CN)

(21) Appl. No.: 18/173,788

(22) Filed: Feb. 24, 2023

Related U.S. Application Data
(63) Continuation of application No. PCT/CN2021/095774, filed on May 25, 2021.

(30) Foreign Application Priority Data
Jan. 11, 2021 (CN) 202120060954.7

(51) Int. Cl. H01R 24/52; H01R 13/504; H01R 13/6581

(52) U.S. Cl. CPC H01R 24/52; H01R 13/504; H01R 13/6581; H01R 2201/26

(57) ABSTRACT

A FAKRA connector, comprising: a metal terminal; a metal housing which is sleeved around outside the metal terminal; a plastic housing which accommodates the metal housing, wherein the plastic housing has a front end and a rear end, the front end of the plastic housing has a port, and a filling space is provided between the rear end of the plastic housing and the metal housing; a sealing and fixing member having an integrally formed structure, at least a portion of the sealing and fixing member being filled in the filling space, to seal and fill a space between the rear end of the plastic housing and the metal housing is sealed and filled. The FAKRA connector can simplify a sealing structure of FAKRA connectors by providing a sealing and fixing member having an integrally formed structure.

### CROSS-REFERENCE TO RELATED APPLICATIONS

This application is a continuation of International Patent Application Number PCT/CN2021/095774, filed on May 25th, 2021, which claims the benefit and priority of Chinese Patent Application Number 202120060954.7, filed on Jan. 11th, 2021, the disclosures of which are incorporated herein by reference in their entireties.

### TECHNICAL FIELD

The utility model relates to the technical field of connector manufacturing, in particular to a FAKRA connector. (FAKRA (Fachkreis Automobil, a german standard) connectors are SMB based automotive-grade connectors that can operate up to 6 GHz.)

### BACKGROUND

The FAKRA connectors are designed for automotive applications, typically for RF signal connectors in automotive industry, GPS positioning systems, satellite radios, and on-board Internet access. The FAKRA connector is usually detachably assembled on a fixed base by means of a fastener, and is mainly composed of several parts such as a protective shell, an inner shielding shell, a plastic insertion core and a metal terminal and the like.

At present, the assembly process of the FAKRA connector is complicated, and generally, it is necessary to sleeve a sealing ring outside the connector and then insert the connector into a plastic shell, and to put a waterproof gasket and a metal plug at the rear end for sealing, and finally, the cable and connector are in sleeve-connection through a heat-shrinkable tube. This not only results in a complex sealing measure for the FAKRA connector, but also in a complex assembly process.

### SUMMARY OF THE INVENTION

In view of the above disadvantages of the prior art, it is an object of the present utility model to provide a FAKRA connector capable of simplifying a sealing structure.

Another object of the present utility model is to provide a FAKRA connector with simple assembly process.

In order to realize the above at least one object, the utility model adopts the following technical solution:

A FAKRA connector, comprising:
a metal terminal;
a metal housing which is sleeved around outside the metal terminal;
a plastic housing which accommodates the metal housing, wherein the plastic housing has a front end and a rear end, the front end of the plastic housing has a port, and a filling space is provided between the rear end of the metal housing and the metal housing;
a sealing and fixing member having an integrally formed structure, at least a portion of the sealing and fixing member being filled in the filling space, to seal and fill a space between the rear end of the plastic housing and the metal housing.

As a preferred embodiment, part of the sealing and fixing member is located outside the plastic housing.

As a preferred embodiment, the FAKRA connector further comprises a cable, wherein one end of the cable extends into the metal housing in the sealing and fixing member and is electrically connected to the metal terminal.

As a preferred embodiment, the sealing and fixing member comprises a filling portion inside the filling space and an extension portion outside the filling space, wherein the extension portion is located on a side of the filling portion that is remote from the plastic housing in an extension direction of the cable.

A FAKRA connector, comprising:
a metal terminal;
a metal housing which is sleeved around outside the metal terminal;
a plastic housing which accommodates the metal housing;
a cable electrically connected to the metal terminal;
a sealing and fixing member having an integrally formed structure, wherein the sealing and fixing member includes a filling portion filled between the metal housing and the plastic housing and an extension portion located outside the plastic housing to sleeve the cable.

As a preferred embodiment, the sealing and fixing member is bonded with the plastic housing.

As a preferred embodiment, the sealing and fixing member is an integrated structure formed by curing a hot melt adhesive.

As a preferred embodiment, the cable has an outer insulating layer; one end of the sealing and fixing member that is remote from the plastic housing is directly bonded outside the outer insulation layer.

As a preferred embodiment, part of the metal housing is sheathed by the sealing and fixing member.

As a preferred embodiment, part of the sealing and fixing member is sheathed between the plastic housing and the metal housing.

As a preferred embodiment, the metal housing has a connecting tube body extending in the same direction as the cable; the cable extends into the connecting tube body and is electrically connected to the metal terminal; the filling portion is filled between one end of the connecting tube body and the inner wall of the plastic housing.

As a preferred embodiment, the metal housing further has an accommodating tube body perpendicular to the connecting portion; the metal terminal is coaxially fixed within the accommodating portion.

As a preferred embodiment, the length of the sealing and fixing member that extends outwards from the plastic housing in the extending direction of the cable is greater than the length of the metal housing that extends out of the plastic housing.

As a preferred embodiment, the sealing and fixing member further comprises a sleeve portion; the sleeve portion sleeves outside the rear end of the plastic housing.

The utility model has the following beneficial effects:

The FAKRA connector provided by an embodiment of the utility model is provided with a sealing and fixing member having an integrally formed structure, the sealing and fixing member seals and fills the gap between the plastic housing and the metal housing, thereby simplify the sealing structure of the FAKRA connector.

Specific embodiment of the utility model is disclosed in detail with reference to the following description and the accompanying drawings, indicating the manner in which the principles of the utility model may be employed. It should be understood that the embodiment of the present utility model is not thus limited in scope.

The features described and/or shown for one embodiment can be used in one or more other embodiments in the same or similar manner, can be combined with the features in other embodiments or replace the features in other embodiments.

It should be emphasized that, the term “include/contain” refers to, when being used in the text, existence of features, parts, steps or assemblies, without exclusion of existence or attachment of one or more other features, parts, steps or assemblies.

### BRIEF DESCRIPTION OF THE DRAWINGS

In order to more clearly explain the embodiments of the utility model or the technical solution in the prior art, drawings that need to be used in the description in embodiments or the prior art will be simply introduced below, obviously the drawings in the following description are merely some examples of the utility model, for persons ordinarily skilled in the art, it is also possible to obtain other drawings according to these drawings without making creative efforts.

FIG. 1 is a sectional view of a FAKRA connector according to an embodiment of the present utility model;

FIG. 2 is a partial schematic view of FIG. 1;

FIG. 3 is a stereoscopic view of FIG. 1;

FIG. 4 is a schematic cross-sectional view of FIG. 3;

FIG. 5 is a structural schematic of a FAKRA connector according to another embodiment of the present utility model;

FIG. 6 is a structural schematic of a FAKRA connector according to another embodiment of the present utility model.

Description of the reference numerals: 100. plastic housing; 101. front end; 102. rear end; 105. port; 109. buckle; 200. metal terminal; 300. cable; 301. core wire; 302. inner insulating layer; 303. shielding layer; 304. outer insulating layer; 400. metal housing; 401. accommodating tube body; 402. connecting tube body; 500. sealing and fixing member; 501. filling portion; 502. extension portion; 503. sleeve portion.

### DETAILED DESCRIPTION OF THE PREFERRED EMBODIMENTS

In order to make those skilled in the art better understand the technical solutions in the present utility model, the technical solutions in the embodiments of the present utility model will be clearly and completely described in the following with reference to the accompanying drawings in the embodiments of the present utility model. Obviously, the described embodiments are only a part of the embodiments of the present utility model, but not all of them. Any other embodiment obtained by those skilled in the art based on the embodiments of the utility model without paying any creative labor fall within the protection scope of the utility model.

It should be noted that when an element is referred to as being “disposed” on another element, it may be directly on another element or there may be another element in the middle. When one element is considered to be “connected” to another element, it may be connected directly to another element or there may be another element in the middle. The terms “vertical,” “horizontal,” “left,” “right” and other similar expressions used herein are used for illustrative purposes only and are not meant to be the only embodiment.

Unless otherwise defined, all technical and scientific terms used herein have the same meanings as that are generally understood by those skilled in the art belonging to the technical field of the present utility model. The terms used herein in the description of the utility model are for purposes of describing specific embodiments only and are not intended to limit the utility model. The terms “and/or” as used herein include any and all combinations of one or more related listed items.

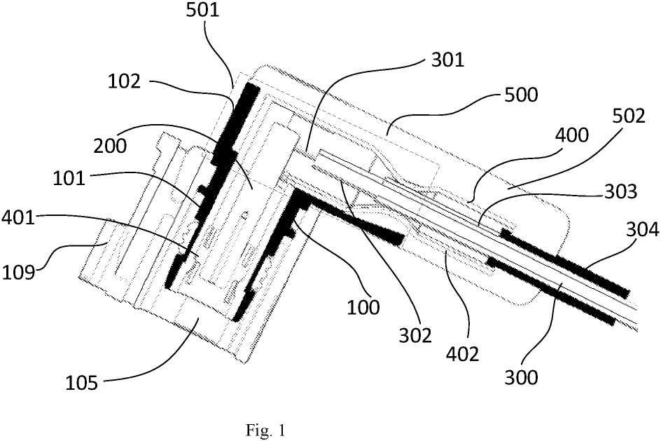

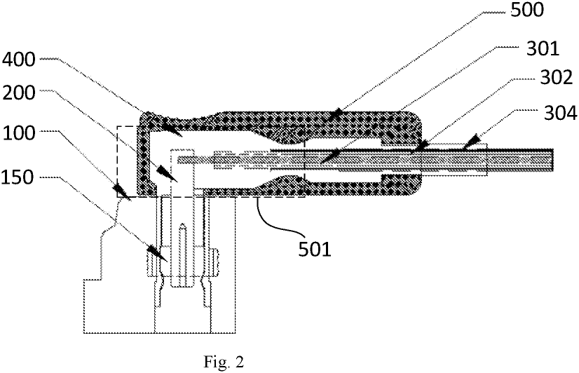

Referring to FIGS. 1 to 3, an embodiment of the utility model provides a FAKRA connector, comprising: a metal terminal 200; a metal housing 400 which is sleeved around outside the metal terminal 200; a plastic housing 100 which accommodates the metal housing 400; and a sealing and fixing member 500. The FAKRA connector further comprises a cable 300 electrically connected to the metal terminal 200.

The core wire 301 of the cable 300 extends into the metal housing 400 and is electrically connected to the metal terminal 200. Specifically, one end of the cable 300 extends into the metal housing 400 in the sealing and fixing member 500 and is electrically connected to the metal terminal 200. Part of the sealing and fixing member 500 is wrapped around the cable 300.

In this embodiment, in order to facilitate the connection and fixing of the FAKRA connector, the plastic housing 100 is further provided with a structure of a buckle 109. Preferably, the structure of the buckle 109 can rotatably sleeve on the plastic housing 100 and the axial position thereof is limited on the plastic housing 100. The plastic housing 100 has a front end 101 and a rear end 102. The front end 101 of the plastic housing 100 has a port 105. The front end 101 of the plastic housing 100 can be a front tube structure, and the front end 101 of the plastic housing 100 sleeves outside the metal housing 400 and the metal terminal 200. The metal terminal 200 is disposed coaxially in the metal housing 400, and the metal housing 400 is disposed coaxially in a lumen of the front end 101 of the plastic housing 100.

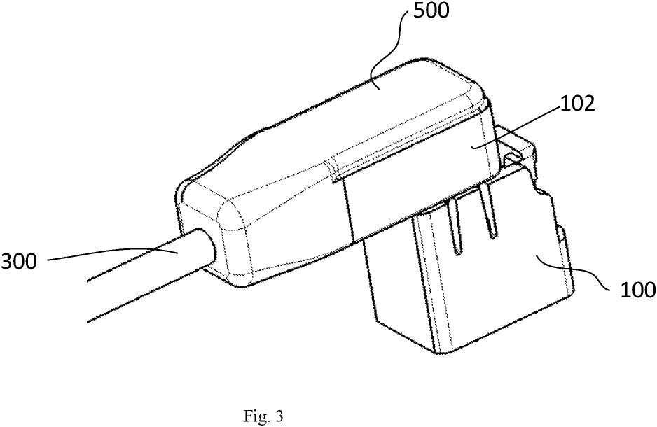

As shown in FIG. 3, the rear end 102 of the plastic housing 100 is a cuboid structure, and a rear top wall and one side wall of the rear end 102 of the cuboid structure that faces away from the port 105 are open structures, thereby forming a rear opening and a side wall opening at the rear end 102 of the cuboid structure. Both the rear opening and the side wall opening are rectangular openings, with the rear opening facing in the opposite direction to the port 105 of the front end 101. A low-pressure injection molding apparatus can inject the hot melt adhesive into the interior of the rear end 102 of the plastic housing 100 through the opening, to be cured and molded to form the sealing and fixing member 500.

A filling space is provided between the rear end 102 of the metal housing 100 and the metal housing 400. The sealing and fixing member 500 has an integrally formed structure. At least a part of the sealing and fixing member 500 is filled in the filling space, to seal and fill a space between the rear end 102 of the plastic housing 100 and the metal housing 400. Part of the sealing and fixing member 500 is located outside the plastic housing 100. The sealing and fixing member 500 includes a filling portion 501 filled between the metal housing 400 and the plastic housing 100 and an extension portion 502 located outside the plastic housing 100 to sleeve the cable 300.

The FAKRA connector provided by the embodiment is provided with a sealing and fixing member 500 having an integrally formed structure, the sealing and fixing member 500 seals and fills the space between the plastic housing 100 and the metal housing 400, thereby simplify the sealing structure of the FAKRA connector.

The sealing and fixing member 500 comprises a filling portion 501 inside the filling space and an extension portion 502 outside the filling space. The shape of the filling portion 501 depends on the shape of the space (filling space) between the metal housing 400 and the inner wall of the rear end 102 of the plastic housing 100. The extension portion 502 is located on a side of the filling portion 501 that is remote from the plastic housing 100 in an extension direction of the cable 300. The extension portion 502 extends rearwardly from the side wall opening and blocks the side wall opening of the rear end 102. The sealing and fixing member 500 further has a cover plate structure which covers the rear opening of the rear end 102 of the plastic housing 100 and is bonded and sealed with the end face of the side wall plate of the rear end 102. The extension portion 502 wraps and secures the wire outside the plastic housing 100.

In this embodiment, the sealing and fixing member 500 is bonded to the plastic housing 100. The sealing and fixing member 500 is an integrated structure formed by curing a hot melt adhesive. The sealing and fixing member 500 forms bonding with the inner wall of the plastic housing 100 when cured. The filling portion 501 wraps the metal housing 400 inside the plastic housing 100 and fills the external space, thereby achieving sealing between the metal housing 400 and the plastic housing 100.

The metal housing 400 is a metal shielding shell, which sleeves outside the metal terminal 200 to improve the shielding performance of the FAKRA connector, so that the signal is protected from external magnetic field during transmission. In addition, by providing the metal housing, the structural strength of the FAKRA connector can be improved, the internal metal terminal 200 can be prevented from being deformed and damaged during mounting, and the connection reliability and mounting accuracy can be ensured.

The cable 300 has an outer insulating layer 304. The cable 300 has a core wire 301, and the outer insulating layer 304 sleeves outside the core wire 301. One end of the sealing and fixing member 500 that is remote from the plastic housing 100 is directly bonded outside the outer insulation layer 304. A (electromagnetic) shielding layer 303 is further provided outside the core wire 301. The metal housing 400 is in electrical contact with the electromagnetic shielding layer 303 of the cable 300. An inner insulating layer 302 is disposed between the core wire 301 and the electromagnetic shielding layer 303 to space the core wire 301 from the electromagnetic shielding layer 303.

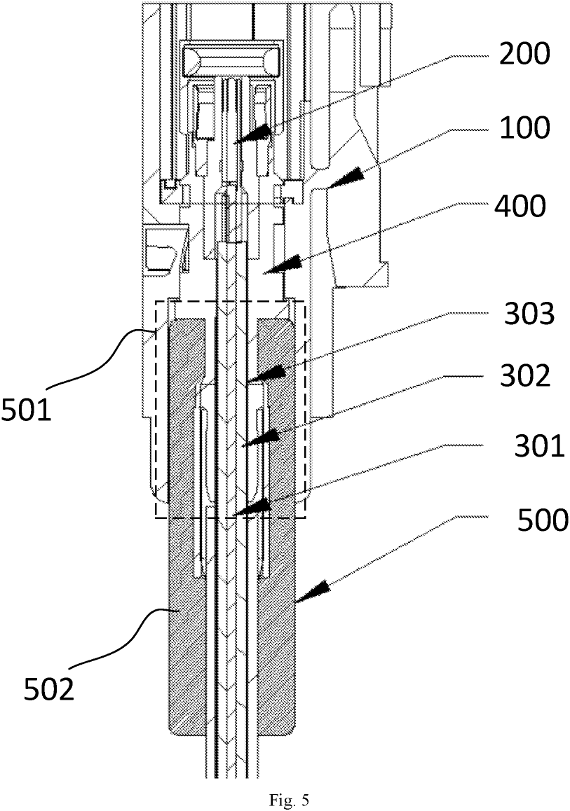

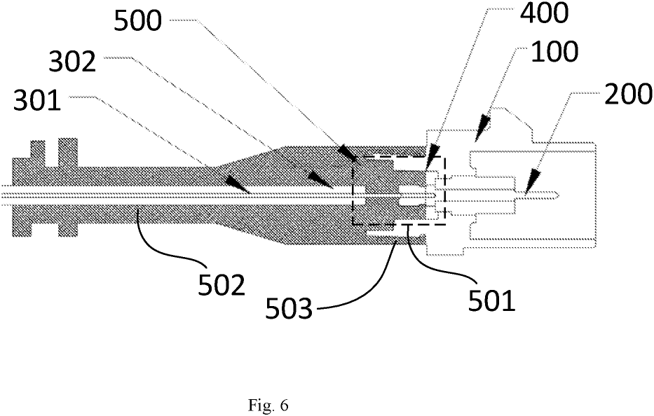

In this embodiment, part of the metal housing 400 is sheathed by (part of) the sealing and fixing member. As shown in FIGS. 5 and 6, part of the sealing and fixing member 500 is sheathed between the plastic housing 100 and the metal housing 400, the space between the rear end 102 of the plastic housing 100 and the metal housing 400 is sealed and filled, and the position of the metal housing 400 can be fixed, and the structural strength can be improved. The metal housing 400 has an outer end extending out of the plastic housing 100. The sealing and fixing member 500 sleeves outside the outer end.

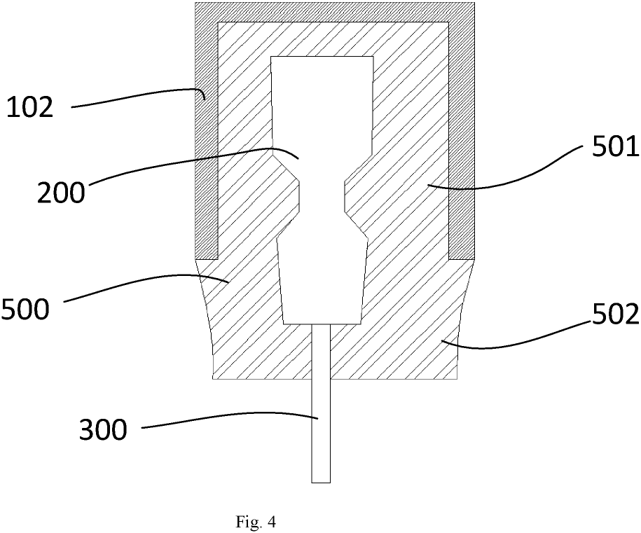

In the embodiments as shown in FIGS. 1 to 4, the metal housing 400 has a connecting tube body 402 extending in the same direction as the cable 300. The cable 300 extends into the connecting tube body 402 and is electrically connected to the metal terminal 200. The filling portion 501 is filled between one end of the connecting tube body 402 and the inner wall of the plastic housing 100. The metal housing 400 further has an accommodating tube body 401 perpendicular to the connecting portion. The metal terminal 200 is coaxially fixed within the accommodating portion.

The accommodating tube body 401 is located within a sleeve tube body of the front end 101 of the plastic housing 100, and the two are arranged coaxially. The metal housing 400 is of an L-shaped tube structure or a cylindrical structure. The metal housing 400 provides an accommodating space of the metal terminal 200 and a connection space between the metal terminal 200 and (the core wire 301 of) the cable 300.

The length of the sealing and fixing member 500 that extends outwards from the plastic housing 100 in the extending direction of the cable 300 is greater than the length of the metal housing 100 that extends out of the plastic housing 400. One end of the metal housing 400 protrudes out of the plastic housing 100 (from the side wall opening), and the outer end is wrapped by the sealing and fixing member 500, and part of the sealing and fixing member 500 sleeves directly outside the cable 300 to prevent the metal housing 400 from being exposed. A stepped hole for accommodating one end of the cable 300 and the metal housing 400 is formed inside the rear end 102 of the plastic housing 100.

In the embodiment shown in FIG. 5, the FAKRA connector is a linear connector, and the metal housing 400 is a connecting tube body 402 (a straight tube structure) that extends axially. The metal terminal 200, the metal housing 400, and the cable 300 are all arranged coaxially. The filling portion 501 is sleeved between the metal housing 400 and (the rear end 102 of) the plastic housing 100, and the extension portion 502 sleeves outside the cable 300 and the metal housing 400 outside the plastic housing 100.

In the embodiment shown in FIG. 6, in order to improve the sealing waterproof performance, the sealing and fixing member 500 further includes a sleeve portion 503. The sleeve portion 503 sleeves outside the rear end 102 of the plastic housing 100. The embodiment shown in FIG. 6 is similar to that shown in FIG. 5, and compared with FIG. 5, the sealing and fixing member 500 of the embodiment shown in FIG. 6 further includes a sleeve portion 503 which sleeves on the rear end 102 of the plastic housing 100, and thus sealing and fixing members 500 are provided on both inner and outer sides of the rear end 102 of the plastic housing 100.

Any numerical value referred to herein includes all values of a lower value and an upper value that are incremented by one unit from a lower limit value to an upper limit value, with an interval of at least two units between any lower value and any higher value. For example, if it is stated that the number of components or process variables such as temperature, pressure, time, etc., have a value from 1 to 90, preferably from 20 to 80, more preferably from 30 to 70, the purpose is to illustrate that the equivalents such as 15 to 85, 22 to 68, 43 to 51, 30 to 32 are also explicitly recited in the specification. For values smaller than 1, one unit is suitably considered to be 0.0001, 0.001, 0.01, 0.1. These are merely intended to be explicitly expressed examples, and it may be considered that all possible combinations of numerical values enumerated between the lowest value and the highest value are explicitly set forth in a similar manner in this specification.

Unless otherwise stated, all ranges include end points and all numbers between the end points. The “about” or “approximate” used with the range is suitable for both end points of the range. Thus, “about 20 to 30” is intended to cover “about 20 to about 30,” including at least the indicated end points.

All articles and references disclosed, including patent applications and publications, are incorporated herein by reference for all purposes. The term “consisting essentially of” to describe a combination should include the elements, components, parts or steps determined and other elements, components, parts or steps that do not substantially affect the substantially novel features of the combination. The use of the terms “comprising” or “including” to describe combination of the elements, components, parts or steps herein also contemplates embodiments that consist essentially of such elements, components, parts or steps. The use of the term “may” herein is intended to illustrate that any of the described attributes that may be included are optional.

The plurality of elements, components, parts or steps can be provided by a single integrated element, component, part or step. Alternatively, the single integrated element, component, part or step may be divided into separate multiple elements, components, parts or steps. A disclosed “a” or “an” used to describe an element, a component, a part or a step does not mean to exclude other elements, components, parts or steps.

It should be understood that the above description is for purposes of illustration and not for purposes of limitation. Many embodiments and many applications other than the examples provided will be apparent to those skilled in the art from reading the above description. Accordingly, the scope of the present teachings should not be determined with reference to the above description, but should be determined with reference to the appended claims and the full scope of equivalents owned by these claims. The disclosure of all articles and references, including patent applications and publications, is incorporated herein by reference for purposes of completeness. The omission of any aspect of the subject matter disclosed herein in the foregoing claims is not intended to waive the subject matter, nor should it be considered that the inventor does not consider the subject matter to be part of the subject matter of the disclosed utility model.

What is claimed is:

1. A FAKRA connector, characterized in comprising: a metal terminal; a metal housing which is sleeved around outside the metal terminal; a plastic housing which accommodates the metal housing, wherein the plastic housing has a front end and a rear end, the front end of the plastic housing has a port, and a filling space is provided between the rear end of the plastic housing and the metal housing; a sealing and fixing member having an integrally formed structure, at least a portion of the sealing and fixing member being filled in the filling space, to seal and fill a space between the rear end of the plastic housing and the metal housing.

2. The FAKRA connector according to claim 1, wherein, part of the sealing and fixing member is located outside the plastic housing.

3. The FAKRA connector according to claim 1, characterized in further comprising a cable, wherein one end of the cable extends into the metal housing in the sealing and fixing member and is electrically connected to the metal terminal.

4. The FAKRA connector according to claim 1, wherein, the sealing and fixing member comprises a filling portion inside the filling space and an extension portion outside the filling space, wherein the extension portion is located on a side of the filling portion that is remote from the plastic housing in an extension direction of the cable.

5. A FAKRA connector, characterized in comprising: a metal terminal; a metal housing which is sleeved around outside the metal terminal; a plastic housing which accommodates the metal housing; a cable electrically connected to the metal terminal; a sealing and fixing member having an integrally formed structure, wherein the sealing and fixing member includes a filling portion filled between the metal housing and the plastic housing and an extension portion located outside the plastic housing to sleeve the cable.

6. The FAKRA connector according to claim 1, wherein, the sealing and fixing member is bonded with the plastic housing.

7. The FAKRA connector according to claim 1, wherein, the sealing and fixing member is an integrated structure formed by curing a hot melt adhesive.

8. The FAKRA connector according to claim 4, wherein, the cable has an outer insulating layer; one end of the sealing and fixing member that is remote from the plastic housing is directly bonded outside the outer insulation layer.

9. The FAKRA connector according to claim 1, wherein, part of the metal housing is sheathed by the sealing and fixing member.

10. The FAKRA connector according to claim 1, wherein, part of the sealing and fixing member is sheathed between the plastic housing and the metal housing.

11. The FAKRA connector according to claim 4, wherein, the metal housing has a connecting tube body extending in the same direction as the cable; the cable extends into the connecting tube body and is electrically connected to the metal terminal; the filling portion is filled between one end of the connecting tube body and the inner wall of the plastic housing.

12. The FAKRA connector according to claim 11, wherein, the metal housing further has an accommodating tube body perpendicular to the connecting portion; the metal terminal is coaxially fixed within the accommodating portion.

13. The FAKRA connector according to claim 4, wherein, the length of the sealing and fixing member that extends outwards from the plastic housing in the extending direction of the cable is greater than the length of the metal housing that extends out of the plastic housing.

14. The FAKRA connector according to claim 1, wherein, the sealing and fixing member further comprises a sleeve portion; the sleeve portion sleeves outside the rear end of the plastic housing.

15. The FAKRA connector according to claim 5, wherein, the sealing and fixing member is bonded with the plastic housing.

16. The FAKRA connector according to claim 5, wherein, the sealing and fixing member is an integrated structure formed by curing a hot melt adhesive.

17. The FAKRA connector according to claim 5, wherein, the cable has an outer insulating layer; one end of the sealing and fixing member that is remote from the plastic housing is directly bonded outside the outer insulation layer.

18. The FAKRA connector according to claim 5, wherein, part of the metal housing is sheathed by the sealing and fixing member.

19. The FAKRA connector according to claim 5, wherein, part of the sealing and fixing member is sheathed between the plastic housing and the metal housing.

20. The FAKRA connector according to claim 5, wherein, the metal housing has a connecting tube body extending in the same direction as the cable; the cable extends into the connecting tube body and is electrically connected to the metal terminal; the filling portion is filled between one end of the connecting tube body and the inner wall of the plastic housing.
